(19) United States
(12) Patent Application Publication
(10) Pub. No.: US 2017/0212401 A1
(43) Pub. Date: Jul. 27, 2017

(54) ELECTROPHORETIC DISPLAY DEVICE, ELECTRONIC APPARATUS, AND METHOD OF MANUFACTURING ELECTROPHORETIC DISPLAY DEVICE

(71) Applicant: Seiko Epson Corporation, Tokyo (JP)

(72) Inventor: Tadashi Yamada, Matsumoto-shi (JP)

(21) Appl. No.: 15/410,870

(22) Filed: Jan. 20, 2017

(30) Foreign Application Priority Data
Jan. 22, 2016 (JP) 2016-010751

(51) Int. Cl. G02F 1/167; G02F 1/133

(52) U.S. Cl. CPC G02F 1/167; G02F 1/13306; G02F 2001/1676

(57) ABSTRACT

An electrophoretic display device includes a first substrate and a second substrate opposed each other; a first electrode provided on the first substrate; a second electrode provided on the second substrate; and a dispersion liquid which includes particles and a dispersion medium, provided between the first electrode and the second electrode, in which, in a state where a voltage for displaying colors corresponding to the particles is applied between the first electrode and the second electrode and the colors are displayed on a side of the second substrate, in a case where the voltage is cancelled, a color other than the color corresponding to the particles is displayed.

### BACKGROUND

1. Technical Field

The present invention relates to an electrophoretic display device, an electronic apparatus, and a method of manufacturing an electrophoretic display device.

2. Related Art

Electrophoretic display devices (EPD: Electrophoretic Display) are, for example, used in electronic paper, and the like.

Electrophoretic display devices are able to change the contents of their displays by applying a voltage to a solvent infused with particles having a charged property and dispersibility so as to move the particles to the side of a predetermined electrode and separating particles with different colors and reflectivities. As an example, in a black and white display using particles corresponding to white (referred to as “white particles”) and particles corresponding to black (referred to as “black particles”), in general, white is displayed using the light scattering of the white particles and black is displayed using the light absorption of the black particles.

As an electrophoretic display device, a holding-type electrophoretic display device is used in which the display contents are held even when the application of a voltage is stopped (refer to JP-A-2009-103967).

However, for example, when the display contents are held in the holding-type electrophoretic display device, the particles (for example, white particles or black particles) may be fixed and held on an electrode so as to be unable to move and the response speed of the particles may be reduced.

In addition, for example, when the display contents are held in the holding-type electrophoretic display device, burn-in over time or residual images may occur. For this reason, burn-in over time or residual images in the holding-type electrophoretic display device have been prevented by refresh driving or driving which reverses the black and white (insertion of a black-and-white reverse image).

In addition, since the refresh driving or driving which reverses the black and white in the holding-type electrophoretic display device is performed during the control of the display, a deterioration in the visibility may occur, unnecessary time may be taken to return the display to the original display, or the display quality (display level) may be poor.

Here, in a situation of being used in an application for sports or the like where it is necessary to change the display every second, it may not be possible to or it may be difficult to carry out the refresh driving or driving which reverses the black and white in the holding-type electrophoretic display device.

As described above, the response speed of the particles in the holding-type electrophoretic display device may be reduced and there have been demands for an electrophoretic display device with a fast particle response speed.

### SUMMARY

An advantage of some aspects of the invention is to provide an electrophoretic display device, an electronic apparatus, and a method of manufacturing an electrophoretic display device which is able to increase the response speed of the particles.

According to one aspect of the invention, there is provided an electrophoretic display device including a first substrate and a second substrate made to oppose each other; a first electrode provided on the first substrate; a second electrode provided on the second substrate; and a dispersion liquid which includes particles and a dispersion medium, provided between the first electrode and the second electrode, in which, in a state where a voltage for displaying colors corresponding to the particles is applied between the first electrode and the second electrode and the colors are displayed on a side of the second substrate, in a case where the voltage is cancelled, a color other than the color corresponding to the particles is displayed.

According to this configuration, in the electrophoretic display device, in a state where a voltage for displaying colors corresponding to the particles is applied between the first electrode and the second electrode and the colors are displayed on a side of the second substrate, in a case where the voltage is cancelled, a color other than the color corresponding to the particles is displayed. Due to this, the electrophoretic display device is a non-holding-type device and it is possible to increase the response speed of the particles and to increase the speed of switching the display contents.

According to the aspect of the invention, in the electrophoretic display device, a configuration may be used in which, in a state where a voltage is not applied between the first electrode and the second electrode, for one or both of the first electrode and the second electrode, a resultant force acting between the electrodes and the particles when the electrodes and the particles are close is a repulsive force.

According to this configuration, the electrophoretic display device is a non-holding-type device. Due to this, in the electrophoretic display device, it is possible to increase the response speed of the particles and to increase the speed of switching the display contents.

According to the aspect of the invention, in the electrophoretic display device, a configuration may be used in which, for one or both of the first electrode and the second electrode, a water-repellent or oil-repellent layer is provided on a surface where the dispersion liquid contacts a side of the electrode.

According to this configuration, the electrophoretic display device is a non-holding-type device due to the water-repellent or oil-repellent layer. Due to this, in the electrophoretic display device, it is possible to increase the response speed of the particles and to increase the speed of switching the display contents.

According to the aspect of the invention, in the electrophoretic display device, a configuration may be used in which the layer is a fluorine layer.

According to this configuration, the electrophoretic display device is a non-holding-type device due to the fluorine layer. Due to this, in the electrophoretic display device, it is possible to increase the response speed of the particles and to increase the speed of switching the display contents.

According to the aspect of the invention, in the electrophoretic display device, a configuration may be used in which, for one or both of the first electrode and the second electrode, an amount or length of a brush part of the particles is set to a value where the resultant force acting between the electrode and the particles is a repulsive force when the electrode and the particles are close.

According to this configuration, the electrophoretic display device is a non-holding-type device due to the amount or length of the brush part of the particles. Due to this, in the electrophoretic display device, it is possible to increase the response speed of the particles and to increase the speed of switching the display contents.

According to another aspect of the invention, there is provided an electronic apparatus including the electrophoretic display device described above.

According to this configuration, in the electrophoretic display device in the electronic apparatus, in a state where a voltage for displaying colors corresponding to the particles is applied between the first electrode and the second electrode and the colors are displayed on a side of the second substrate, in a case where the voltage is cancelled, a color other than the color corresponding to the particles is displayed. Due to this, the electrophoretic display device in the electronic apparatus is a non-holding-type device and it is possible to increase the response speed of the particles and to increase the speed of switching the display contents.

According to still another aspect of the invention, there is provided a method of manufacturing an electrophoretic display device provided with a first substrate and a second substrate made to oppose each other; a first electrode provided on the first substrate; a second electrode provided on the second substrate; and a dispersion liquid which includes particles and a dispersion medium, provided between the first electrode and the second electrode, the method including performing one or both of forming a water-repellent or oil-repellent layer on a surface where the dispersion liquid contacts a side of the electrode for one or both of the first electrode and the second electrode, or providing the dispersion liquid where, for one or both of the first electrode and the second electrode, an amount or length of a brush part of the particles is set to a value where the resultant force acting between the electrode and the particles is a repulsive force when the electrode and the particles are close.

According to this configuration, in the method of manufacturing an electrophoretic display device, a non-holding-type electrophoretic display device is manufactured. Due to this, in the electrophoretic display device, it is possible to increase the response speed of the particles and to increase the speed of switching the display contents.

As described above, according to the electrophoretic display device, the electronic apparatus, and the method of manufacturing an electrophoretic display device according to the invention, the electrophoretic display device is a non-holding-type device. Due to this, according to the electrophoretic display device, the electronic apparatus, and the method of manufacturing an electrophoretic display device according to the invention, in the electrophoretic display device, it is possible to increase the response speed of the particles and to increase the speed of switching the display contents.

### BRIEF DESCRIPTION OF THE DRAWINGS

The invention will be described with reference to the accompanying drawings, wherein like numbers reference like elements.

FIG. 1 is a diagram which shows a schematic configuration example of a non-holding-type electrophoretic display device according to an embodiment (first embodiment) of the invention.

FIG. 2 is a diagram which shows a configuration example of a display portion of an electrophoretic display device according to the embodiment of the invention.

FIG. 3 is a diagram which shows an example of a state in a case where there is no electrophoretic particle fixing according to the embodiment of the invention.

FIG. 4 is a diagram which shows an example of a state in a case where there is electrophoretic particle fixing according to a comparative example.

FIG. 5 is a diagram which shows an example of response speed when switching display colors.

FIG. 6 is a diagram for illustrating increases in the efficiency of power consumption in a non-holding-type device according to the embodiment of the invention.

FIG. 7 is a diagram for illustrating improvement of the display quality in the non-holding-type device according to the embodiment of the invention.

FIG. 8 is a diagram for illustrating improvement of the display quality in the non-holding-type device according to the embodiment of the invention.

FIG. 9 is a diagram for illustrating adjustment of a particle brush amount according to the first embodiment of the invention.

FIG. 10 is a diagram which shows an example of interaction between electrophoretic particles and an electrode in a case of using fluorine.

FIG. 11 is a diagram which shows an example of interaction between the electrophoretic particles and the electrode in a case of using the adjustment of the brush part amount.

FIG. 12 is a diagram which shows a schematic configuration example of an electronic apparatus according to an embodiment (first example of second embodiment) of the invention.

FIG. 13 is a diagram which shows a schematic configuration example of the electronic apparatus according to an embodiment (second example of second embodiment) of the invention.

FIG. 14 is a diagram which shows a schematic configuration example of an electronic apparatus according to an embodiment (third example of second embodiment) of the invention.

### DESCRIPTION OF EXEMPLARY EMBODIMENTS

A detailed description will be given of the embodiments of the invention with reference to the drawings.

### First Embodiment

### Summary of Electrophoretic Display Device

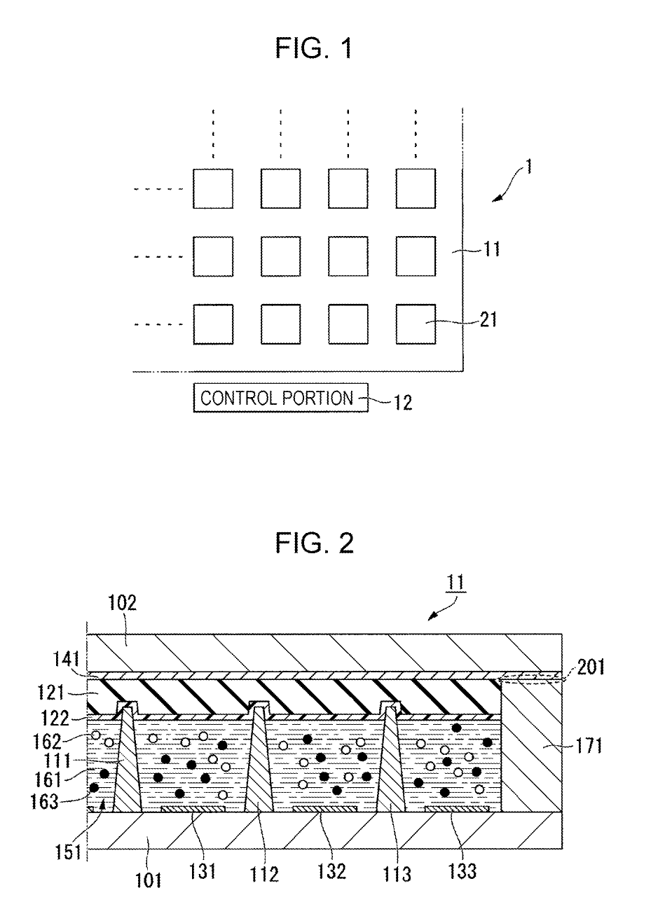

FIG. 1 is a diagram which shows a schematic configuration example of a non-holding-type electrophoretic display device 1 according to an embodiment (the first embodiment) of the invention. FIG. 1 is a planar diagram of the electrophoretic display device 1.

The electrophoretic display device 1 is provided with a display portion 11 and a control portion 12.

The display portion 11 is provided with a plurality of pixel regions 21 arranged vertically and horizontally (in a matrix).

The control portion 12 controls colors to be displayed by controlling the voltage which is applied to the dispersion liquid for each of the pixel regions 21. In the present embodiment, there is a dispersion liquid including white particles and black particles along with a dispersion medium for each of the pixel regions 21 and it is possible to make a white display using white particles and a black display using black particles.

### Summary of Display Portion

FIG. 2 is a diagram which shows a configuration example of the display portion 11 of the electrophoretic display device 1 according to the embodiment of the invention. FIG. 2 is a cross-section side diagram of the display portion 11 and shows a portion corresponding to the pixel region 21 at a part positioned on the side surface at the outer periphery.

Here, in the present embodiment, among the plurality of pixel regions 21, the configurations of two or more pixel regions 21 facing the outer periphery are the same and, in addition, the configurations of two or more pixel regions 21 which do not face the outer periphery are the same. In addition, the configurations of the pixel regions 21 which face the outer periphery and the configurations of the pixel regions 21 which do not face the outer periphery are the same except for a portion which is different depending on whether or not the pixel regions 21 face the outer periphery.

The display portion 11 is provided with a first substrate (referred to below as a “pixel substrate”) 101, a second substrate (referred to below as a “counter substrate”) 102, partition walls 111 to 113, a first bonding layer 121, a second bonding layer 122, first electrodes (referred to below as “pixel electrodes”) 131 to 133, a second electrode (referred to below as a “counter electrode”) 141, a dispersion liquid 151, and a sealing portion 171. The dispersion liquid 151 includes a dispersion medium 161, a plurality of a first type of electrophoretic particles (referred to below as “white particles”) 162, and a plurality of a second type of electrophoretic particles (referred to below as “black particles”) 163.

Here, the “pixel substrate” may be referred to as a “driving substrate” or the like and the “counter electrode” may be referred to as a “common electrode” or the like.

The pixel substrate 101 and the counter substrate 102 are arranged to oppose each other.

Between the pixel substrate 101 and the counter substrate 102, the partition walls 111 to 113 are provided on the pixel substrate 101. Spaces (cells) are formed in the plurality of pixel regions 21 partitioned by the partition walls 111 to 113.

Between the pixel substrate 101 and the counter substrate 102, electrodes (pixel electrodes) 131 to 133 are provided for each of the pixel regions 21 on the pixel substrate 101.

Between the pixel substrate 101 and the counter substrate 102, the electrode (counter electrode) 141 is provided on the counter substrate 102. In the present embodiment, the counter electrode 141 is a common electrode for a plurality of the pixel regions 21; however, as another configuration example, the counter electrode 141 may be provided to be divided for each of the pixel electrodes 131. Here, for example, a glass substrate may be used as the counter substrate 102 and, for example, an electrode of indium tin oxide (ITO) or the like may be used as the counter electrode 141.

Between the pixel substrate 101 and the counter substrate 102, the first bonding layer 121 (for example, a bite layer) is provided on the counter substrate 102 closer to the side of the pixel substrate 101 than the counter electrode 141, and the second bonding layer 122 (for example, a protective film layer) is provided on the side of the pixel substrate 101. Here, the second bonding layer 122 and the leading portions (leading portions on the side of the counter substrate 102) of the partition walls 111 to 112 are in contact.

The dispersion liquid 151 is provided in each of the pixel regions 21.

The sealing portion 171 is provided on the side surface on the outer periphery of the display portion 11 and seals the dispersion liquid 151. Here, a bonding portion 201 of the sealing portion 171 and the counter electrode 141 carries out the bonding by, for example, coating a sealing material.

In the electrophoretic display device 1, the control portion 12 controls the colors (in the present embodiment, black or white) displayed in each of the pixel regions 21 by driving the voltage to control the voltage applied to each of the pixel electrodes 131 to 133 and the voltage applied to the counter electrode 141. Due to this, the display contents on the display surface are controlled. In the present embodiment, the surface of the side of the counter substrate 102 is the display surface which outputs the display contents.

For example, a voltage is applied between the pixel electrodes 131 to 133 and the counter electrode 141 such that the voltage of the counter electrode 141 is relatively high. By doing so, the positively charged black particles 163 are attracted to the side of the pixel electrodes 131 to 133 by Coulomb force. On the other hand, the negatively charged white particles 162 are attracted to the side of the counter electrode 141 by Coulomb force. As a result, the white particles 162 gather at the side of the display surface (side of the counter electrode 141) and a color (white) corresponding to the white particles 162 is displayed on the display surface.

In contrast, a voltage is applied between the pixel electrodes 131 to 133 and the counter electrode 141 such that the potential of the pixel electrodes 131 to 133 is relatively high. By doing so, the negatively charged white particles 162 are attracted to the side of the pixel electrodes 131 to 133 by Colomb force. On the other hand, the positively charged black particles 163 are attracted to the side of the counter electrode 141 by Colomb force. As a result, the black particles 163 are gathered at the side of the display surface (the side of the counter electrode 141) and a color (black) corresponding to the black particles 163 is displayed on the display surface.

Here, in the present embodiment, the partition walls 111 to 113 are provided on the side of the pixel substrate 101 and bonding layers (the first bonding layer 121 and the second bonding layer 122) are provided on the side of the counter substrate 102; however, as another configuration example, a configuration may be used in which bonding layers (the first bonding layer 121 and the second bonding layer 122) are provided on the side of the pixel substrate 101 and the partition walls 111 to 113 are provided on the side of the counter substrate 102.

In addition, in the present embodiment, the two bonding layers (the first bonding layer 121 and the second bonding layer 122) are provided; however, as another configuration example, one bonding layer may be provided.

In addition, in the present embodiment, the white particles 162 and the black particles 163 are used; however, as another configuration example, particles corresponding to other colors may be used.

In addition, in the present embodiment, two types of particles corresponding to two colors (white and black) are used as the particles included in the dispersion liquid 151; however, as another configuration example, one type of particles corresponding to one color may be used, or three or more types of particles corresponding to three colors or more may be used.

For example, by using pigments such as red, green, or blue, it is also possible to obtain the electrophoretic display device 1 provided with the display portion 11 which displays red, green, blue, and the like.

In addition, as another configuration example, a light guide portion and a light emitting portion may be provided on the counter substrate 102 on the side opposite to the pixel substrate 101. The light guide portion guides the light emitted from the light emitting portion and a front light is realized due to this. In such a case, in order to bond the pixel substrate 101 and the light guiding portion, an adhesive portion, a frame, or the like may be provided. As the light emitting portion, for example, a light emitting diode (LED) may be used.

Here, as another configuration example, a back light may be used.

In addition, in the present embodiment, as a shape in which spaces (closed spaces which form cells) for each pixel region 21 formed by the partition walls 111 to 113 are lined up, square shapes (for example, shapes in which squares or rectangles are lined up) are used; however, as another configuration example, another shape such as a honeycomb shape (a shape in which hexagonal columns are lined up), or the like may be used.

### Summary of Non-Holding-type Electrophoretic Display Device

Here, as a configuration example which realizes the non-holding-type electrophoretic display device 1, a non-holding-type configuration example using fluorine and a non-holding-type configuration example which adjusts the brush part of the particles are illustrated. Here, either one of the non-holding-type configuration example using fluorine and the non-holding-type configuration example which adjusts the brush part of the particles may be used, or both may be used.

### Non-Holding-type Configuration Example Using Fluorine

In the present configuration example, on the side of the counter electrode 141 provided on the counter substrate 102, the fluorine is provided on the surface which contacts the electrophoretic particles (in the present embodiment, the white particles 162 and the black particles 163). In the present embodiment, the fluorine is provided in the second bonding layer 122 on the surface where the second bonding layer 122 and the dispersion liquid 151 come into contact. A fluorine layer is, for example, able to have one or both characteristics of water repellency and oil repellency.

As a method of providing fluorine, for example, a method of providing a fluorine layer by coating fluorine (for example, a fluorine resin) or a method of providing a fluorine layer by affixing a fluorine (for example, a fluorine resin) film may be used. As the coating method, for example, spin-coating, spray coating, or the like may be used. As the method of affixing the film, for example, a method of laminating by heating in a vacuum state, or the like may be used. In addition, as a fluorine resin, for example, a conductive resin may be used.

In addition, in the present embodiment, the second bonding layer 122 itself may be formed using fluorine.

In this manner, in a configuration in which fluorine (for example, fluorine resin) is present on the surface of the side of the counter electrode 141 provided on the counter substrate 102 (in the present embodiment, the surface of the second bonding layer 122) and the fluorine and the dispersion liquid 151 are in contact, since a bond such as a hydrogen bond or the like between the fluorine and the electrophoretic particles is not formed, for example, even when van der Waals force which holds the electrophoretic particles acts on the side of the counter electrode 141, the electrophoretic particles are easily separated from the surface of the side of the counter electrode 141 due to external force. Due to this, a non-holding-type device where the electrophoretic particles are not held on the side of the counter electrode 141 is realized.

Specific examples will be given.

In the first specific example, the first bonding layer 121 and the second bonding layer 122 are provided and a fluorine layer is provided as the second bonding layer 122. The first bonding layer 121 is configured using a hydrin rubber and has a layer thickness of 15 μm (the length in the direction in which the pixel substrate 101 and the counter substrate 102 oppose each other, the same applies below). The second bonding layer 122 is formed as a fluorine resin layer and has a layer thickness of 0.3 μm. The volume resistivity of the hydrin rubber is 1E8 (=1×10⁸) [Ω cm] or less and the volume resistivity of the second bonding layer 122 is 1E12 (=1×10¹²) [Ω cm] or less. As another configuration example, NBR rubber (nitrile rubber), urethane rubber, or the like may be used as the first bonding layer 121.

In the second specific example, the structure of a single layer is formed by integrating the first bonding layer 121 and the second bonding layer 122. For example, in a case where the elastic modulus of the second bonding layer 122 formed by the fluorine resin is 100 MPa or less, the single layer structure may be used. The one layer is formed using a single layer fluorine film and has a layer thickness of 10 to 30 μm. The volume resistivity is 1E9 (=1×10⁹) [Ω cm] or less.

Here, in the present embodiment, a configuration is shown in which fluorine is provided on the surface (in the present embodiment, the surface of the second bonding layer 122) on the side of the counter electrode 141 provided on the counter substrate 102; however, as another configuration example, a configuration may be used in which, on the side of the pixel electrodes 131 to 133 provided on the pixel substrate 101, fluorine is provided on the surface with which the electrophoretic particles (in the present embodiment, the white particles 162 and the black particles 163) come into contact. This surface is the surface of the pixel electrodes 131 to 133 in a case where the pixel electrodes 131 to 133 are in contact with the dispersion liquid 151 and, in a case where an insulation layer or the like which contacts the dispersion liquid 151 is provided between the pixel electrodes 131 to 133 and the dispersion liquid 151, the surface may be the insulation layer or the like.

In addition, either one of a configuration in which fluorine is provided on the surface on the side of the counter electrode 141 provided on the counter substrate 102 and a configuration in which fluorine is provided on the surface on the side of the pixel electrodes 131 to 133 provided on the pixel substrate 101 may be used, or both may be used.

Here, normally, it is considered that a configuration in which fluorine is provided more on the side of the counter substrate 102 (the counter electrode 141) which is the display surface than on the side of the pixel substrate 101 (pixel electrodes 131 to 133) which is not the display surface is preferable; however, another configuration may be used.

### Non-Holding-Type Configuration Example Adjusting Particle Brush Part

In the present configuration example, the electrophoretic particles (in the present embodiment, the white particles 162 and the black particles 163) have a configuration in which the brush part is adjusted. The brush part is, for example, a high polymer added to the electrophoretic particles. In addition, the adjustment of the brush part is, for example, either one of or both of increasing the brush part amount added to the electrophoretic particles or lengthening the brush part added to the electrophoretic particles.

In this manner, it is considered that, as the amount of the brush part added to the electrophoretic particles is increased or as the length of the brush part added to the electrophoretic particles is lengthened, the steric repulsion distance between the surface (in the present embodiment, the surface of the second bonding layer 122) on the side of the counter electrode 141 provided on the counter substrate 102 and the electrophoretic particles is increased. Due to this, a non-holding-type device where the electrophoretic particles are not held on the side of the counter electrode 141 is realized.

Here, a description will be given of the amount of the brush part added to the electrophoretic particles (also referred to below as “particle brush amount”).

The particle brush amount may be made to be different according to the structure of the brush part, the manufacturing process for adding the brush part to the electrophoretic particles, or the like. Empirically, in a case where a silicon-based brush part is modified on titanium oxide or titanium nitride, the particle brush amount is as in the following specific examples (the first specific example to the third specific example). Here, in the white particles 162, an alumina coating is applied on the surface of titanium oxide and, in addition, in the black particles 163, a silica coating is applied on the surface of the titanium nitride.

The first specific example is a single point bond silane coupling-type brush part. The manufacturing process is silane coupling with a solvent (silicone oil). In such a case, the particle brush amount of the white particles 162 is 1 to 3% and the particle brush amount of the black particles 163 is 2 to 4%.

The second specific example is a multi-point bond silane coupling-type brush part. The manufacturing process is silane coupling with a solvent (silicone oil). In such a case, the particle brush amount of the white particles 162 is 3 to 5% and the particle brush amount of the black particles 163 is 3 to 6%.

The third specific example is a multi-point bond silane coupling-type brush part. The manufacturing process is silane coupling with no solvent. In such a case, the particle brush amount of the white particles 162 is 5 to 25% and the particle brush amount of the black particles 163 is 6 to 25%.

Here, for example, in a case where a plurality of types of electrophoretic particles are used, increasing the amount of the brush part added to the electrophoretic particles or lengthening the brush part added to the electrophoretic particles may be performed with regard to all types of the electrophoretic particles or may be performed with regard to one type or more of an arbitrary part of the electrophoretic particles. For example, in a case where a plurality of types of electrophoretic particles are used, it is considered that an example where the above is performed with regard to all types of the electrophoretic particles is preferable; however, even when the above is performed with regard to a part of the electrophoretic particles, it is considered that the effect is obtained for that part.

### Comparison of Presence or Absence of Fixing of Electrophoretic Particles

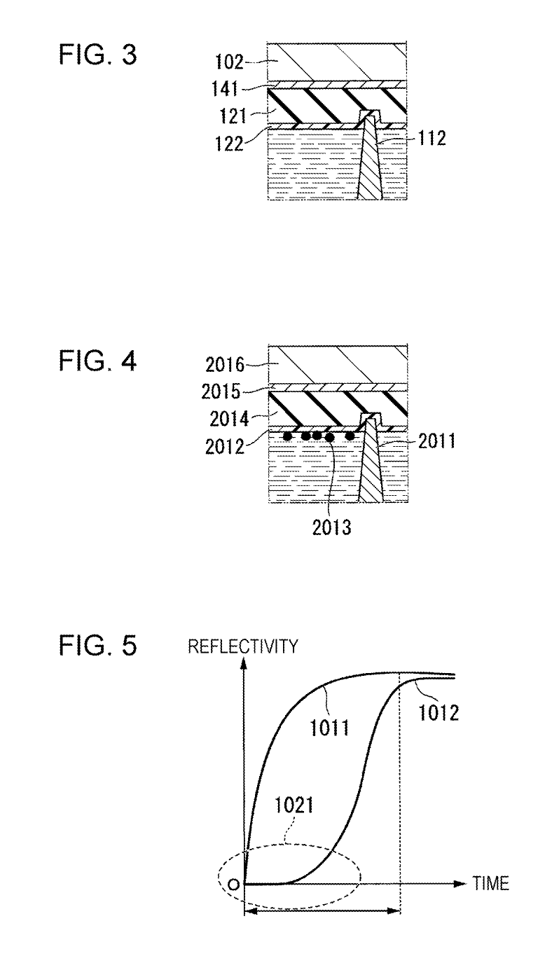

FIG. 3 is a diagram which shows an example of a state in a case where there is no electrophoretic particle fixing according to the embodiment of the invention.

FIG. 3 shows the partition wall 112, the second bonding layer 122, the first bonding layer 121, the counter electrode 141, and the counter substrate 102, and other constituent portions are omitted from the illustration.

In the non-holding-type device as in the present embodiment, after one type of electrophoretic particles (in the present embodiment, the white particles 162 or the black particles 163) is fixed to the surface of the side of the counter electrode 141 by applying a predetermined voltage between the pixel electrodes 131 (the same also applies to the other pixel electrodes 132 and 133) and the counter electrode 141, the electrophoretic particles are separated from the surface without being fixed to the surface of the side of the counter electrode 141 when the application of the voltage is stopped.

FIG. 4 is a diagram which shows an example of a state in a case where there is electrophoretic particle fixing according to a comparative example.

FIG. 4 shows a partition wall 2011, a second bonding layer 2012, one type of electrophoretic particles 2013 (in the comparative example, white particles or black particles), a first bonding layer 2014, a counter electrode 2015, and a counter substrate 2016, and other constituent portions are omitted from the illustration.

In the holding-type device as in the comparative example, after the one type of the electrophoretic particles 2013 are fixed to the surface of the side of the counter electrode 2015 by applying a voltage between the pixel electrodes and the counter electrode 2015, the electrophoretic particles 2013 are fixed on the surface of the side of the counter electrode 2015 even when the application of the voltage is stopped.

Here, an example of evaluation results of the fixing will be given.

For the non-holding-type device shown in FIG. 3, in the evaluation results relating to switching from a black display in a case of using a fluorine film, a decrease in the white reflectivity was within 1% with 1,000,000 instances of driving.

On the other hand, for the holding-type device shown in FIG. 4, in a case of using hydrin rubber as the first bonding layer 2014 and using PVA (polyvinylalcohol) as the second bonding layer 2012, in the evaluation results relating to switching from the black display, the white reflectivity had a 3% decrease with 1,000,000 instances of driving.

FIG. 5 is a diagram which shows an example of response speed when switching display colors.

In the graph shown in FIG. 5, the horizontal axis represents the time and the vertical axis represents the reflectivity. The graph shows a non-holding-type device characteristic 1011 as in the present embodiment and a holding-type device characteristic 1012 according to a comparative example in a case of switching from a black display to a white display. The graph shows a case where the voltage of the black display is switched to the voltage of the white display at the origin point of the time on the horizontal axis. In the non-holding-type device characteristic 1011, the electrophoretic particles (in the present example, the black particles) are separated from the surface of the side of the counter electrode in an early period. On the other hand, in the holding-type device characteristic 1012, as shown in a region 1021, the time in which the electrophoretic particles (in the present example, the black particles) are fixed on the surface of the side of the counter electrode increases and peeling the electrophoretic particles from the surface takes time.

Here, between the black and the white, there is a neutral color (in the present example, gray). For example, in the non-holding-type device, in a case where the driving of the voltage is stopped, the color approaches the neutral color.

An example of the evaluation results of the response speed from black to white will be given.

In a case where a fluorine film is used for the non-holding-type device shown in FIG. 3, the response speed from black to white was 0.08 seconds.

On the other hand, for the holding-type device shown in FIG. 4, in a case of using hydrin rubber as the first bonding layer 2014 and using polyvinylalcohol (PVA) as the second bonding layer 2012, the response speed from black to white was 0.3 to 0.4 seconds.

### Increasing Efficiency of Power Consumption in Non-Holding-Type Device

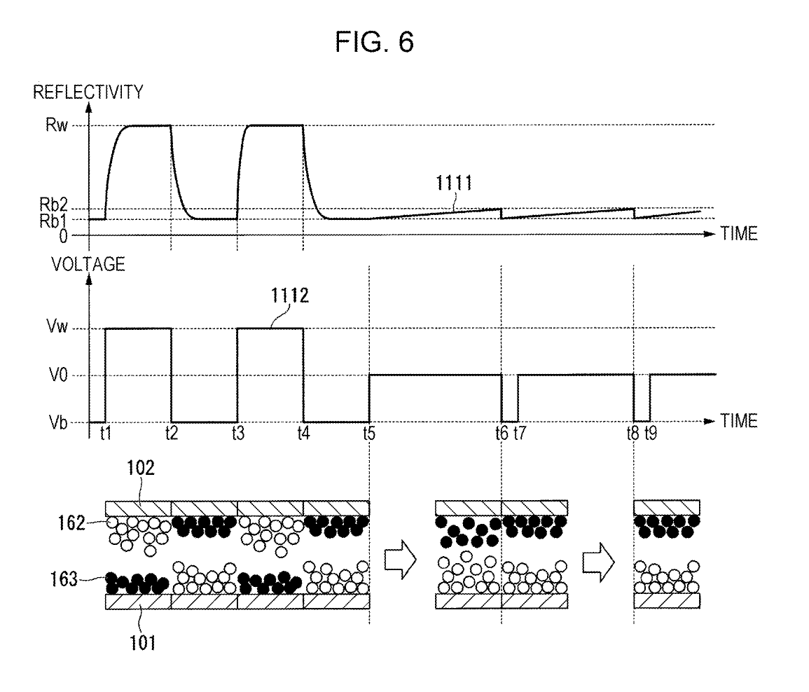

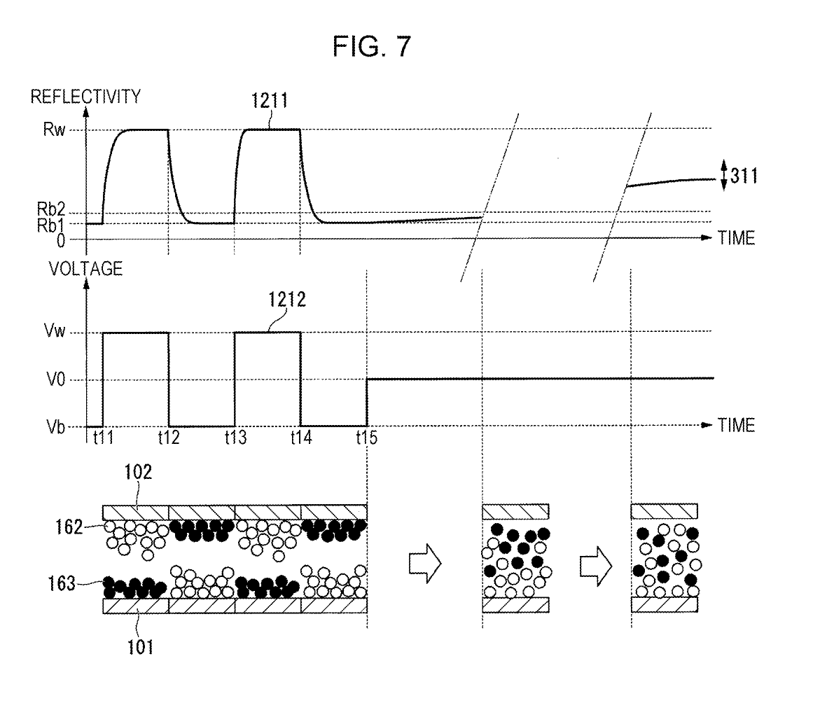

FIG. 6 is a diagram for illustrating increasing the efficiency of power consumption in a non-holding-type device according to the first embodiment of the invention.

FIG. 6 shows the temporal correlation in a graph which represents a reflectivity characteristic 1111 (in the description of FIG. 6, referred to as the “reflectivity graph”), a graph which represents a characteristic 1112 of the voltage applied between the pixel electrodes 131 (the same also applies to the other pixel electrodes 132 and 133) and the counter electrode 141 (in the description of FIG. 6, referred to as “voltage graph”), and an example (other constituent portions are omitted from the illustration) of a state of the white particles 162 and the black particles 163 between the pixel substrate 101 and the counter substrate 102.

In the reflectivity graph, the horizontal axis represents the time and the vertical axis represents the reflectivity.

In the voltage graph, the horizontal axis represents the time and the vertical axis represents the voltage.

As the time on the horizontal axis, time periods t1 to t9 are shown.

In the reflectivity graph, with respect to the vertical axis, 0 is set as the base, Rb1 as the black reflectivity, Rb2 as the slightly deteriorated black reflectivity black, and Rw as the white reflectivity. In the present example, 0<Rb1<Rb2<Rw.

In the voltage graph, with respect to the vertical axis, V0 is set as the base, Vb is set as the voltage (driving voltage) for the black display, and Vw is set as the voltage (driving voltage) for the white display. In the present example, Vb<V0<Vw and, as long as these voltages satisfy a magnitude relationship (magnitude relationship including both positive and negative), the values may be each be positive or negative. Here, in the present embodiment, V0=0 [V] and V0 is the voltage when the application of the driving voltage (Vb or Vw) corresponding to the color of the electrophoretic particles is cancelled (turned off).

In the example of FIG. 6, from time t1 to time t2, a white display is realized by applying the voltage Vw, from time t2 to time t3, a black display is realized by applying the voltage Vb, from time t3 to time t4, a white display is realized by applying the voltage Vw, and from time t4 to time t5, a black display is realized by applying the voltage Vb. Subsequently, from time t5 to time t6, the display is changed from a black display to a gray display by applying the voltage V0. Then, from time t6 to time t7, by applying the voltage Vb, the display changed to a gray display is returned to a black display. Similarly, from time t7 to time t8, by applying the voltage V0, the display is changed from a black display to a gray display. Then, from time t8 to time t9, by applying the voltage Vb, the display changed to a gray display is returned to a black display.

Here, as the voltage control from time t1 to time t2 (the same applies to time t3 to time t4), for example, an aspect may be used in which a voltage Vw is applied for the first predetermined time (for example, the first 400 ms in one second) in the period from time t1 to time t2 and a voltage V0 is applied for the remaining time (for example, the remaining 600 ms in one second).

In addition, as the voltage control from time t2 to time t3 (the same applies to time t4 to time t5), for example, an aspect may be used in which a voltage Vb is applied for the first predetermined time (for example, the first 400 ms in one second) in the period from time t2 to time t3 and the voltage V0 is applied for the remaining time (for example, the remaining 600 ms in one second).

Here, in the non-holding-type device, since the display contents are not held when the application of the voltage is stopped, it is considered that power is necessary in a case where the display contents are held.

In this regard, in the electrophoretic display device 1 according to the present embodiment, when the display contents are held, the power consumption is low (preferably, the minimum power consumption). As an example, the power consumption is reduced in the electrophoretic display device 1 according to the present embodiment by making the time band of the pulse of the voltage driving the display portion 11 shorter (narrower) than the normal driving time (the time for switching the color of the display). As another example, the power consumption is reduced in the electrophoretic display device 1 according to the present embodiment by making the duty of the voltage driving the display portion 11 shorter (smaller) than the normal driving time (the time for switching the color of the display). Here, in comparison with the normal driving time, when the display contents are held, for example, a configuration may be used in which the pulse time band of the voltage is shortened by making the duty the same, a configuration may be used in which the duty of the voltage is shortened by making the pulse time band the same, or a configuration may be used in which both shortening of the time band of the pulse of the voltage and shortening of the duty are performed.

Specific examples will be given.

In a case where the non-holding-type electrophoretic display device 1 is used in the display of a watch, it is necessary to perform the driving in order to hold the display contents when the duty of the driving is short such as when the display contents are switched every minute (=60 seconds) or when the duty of the driving is long such as when the display contents are switched every second.

In this regard, in the electrophoretic display device 1 according to the present embodiment, when the display contents are switched every second, normal driving (switching the display contents) is performed every second (that is, per second). In contrast, in the electrophoretic display device 1 according to the present embodiment, when the display contents are switched every minute, normal driving (switching the display contents) is performed every minute (that is, per minute) and driving for holding is performed every second (that is, every second). Here, in the driving for holding, one or both of shortening the time band of the pulse of the voltage which drives the display portion 11 compared to the normal driving and shortening the duty of the voltage which drives the display portion 11 is performed.

An example of a case where the driving control shown in FIG. 6 is applied to a watch will be given.

The period of time t1 to t5 is an example of a period of switching the display contents every second. For example, with respect to time t1, time t2, time t3, time t4, and time t5 are set to one second intervals. That is, the normal driving is performed at a constant cycle of one second intervals.

In contrast, the period of time t5 to t9 is an example of a period of switching the display contents every minute. For example, the time between time t5 and time t6 is approximately 9 seconds and the time between time t6 and time t7 is approximately one second (may be shorter such that the application time of the voltage is 400 ms), and the time between time t7 and time t8 is approximately 9 seconds and the time between time t8 and time t9 is approximately one second (may be shorter such that the application time of the voltage is 400 ms). That is, normal driving is performed at a constant cycle of one minute interval and driving for holding is performed at a constant cycle at an interval of approximately 10 seconds in that one minute (between normal driving and normal driving). In the example of FIG. 6, due to the driving for holding, the state returns to a black state (Rb1) from a state (Rb2) in which the black is deteriorated such that the display contents are held. Here, as another example, a configuration may be used in which the driving for holding is set to a constant cycle of a one second interval to shorten the time band of the pulse of the voltage which drives the display portion 11 (for example, to 100 ms, 50 ms, or the like).

FIG. 6 simplifies and schematically shows the driving waveform which drives the plurality of pixel regions 21 arranged vertically and horizontally (in a matrix shape) in the display portion 11 for the purpose of illustration. In practice, for example, application may be made to a segment panel provided with only simple pixel electrodes, a passive matrix panel, a TFT panel provided with a pixel memory or a pixel selection circuit in pixels in a matrix form, or the like. In addition, application may be made to various driving panels.

### Improve Display Quality in Non-Holding-Type Device

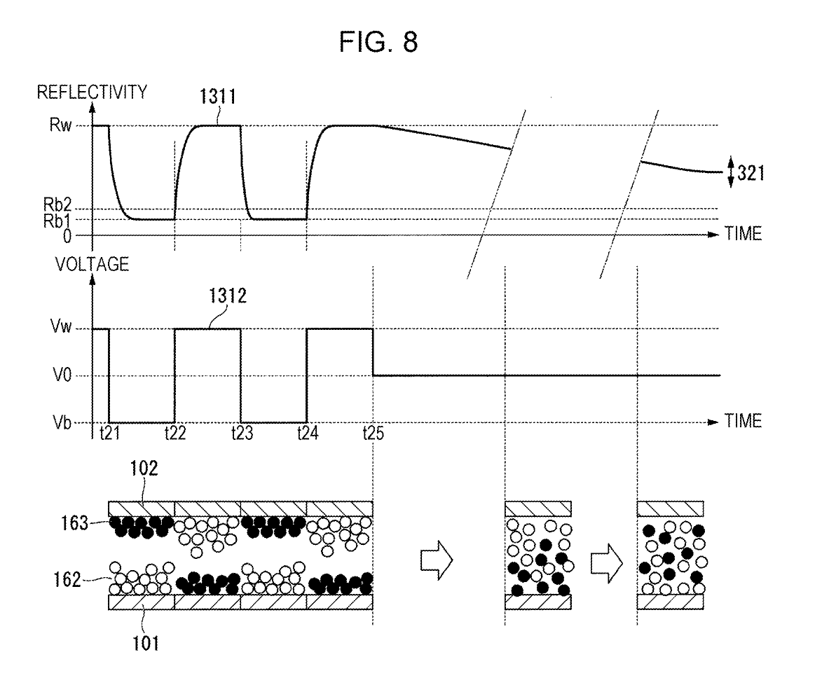

FIG. 7 and FIG. 8 are diagrams for illustrating improvement of the display quality in the non-holding-type device according to one embodiment of the invention.

FIG. 7 and FIG. 8 show the temporal correlation in a graph which represents reflectivity characteristics 1211 and 1311 (in the description of FIG. 7 and FIG. 8, referred to as the “reflectivity graph”), a graph which represents characteristics 1212 and 1312 of the voltage applied between the pixel electrodes 131 (the same also applies to the other pixel electrodes 132 and 133) and the counter electrode 141 (in the description of FIG. 7 and FIG. 8, referred to as “voltage graph”), and an example of a state of the white particles 162 and the black particles 163 between the pixel substrate 101 and the counter substrate 102 (other constituent portions are omitted from the illustration).

In the reflectivity graph, the horizontal axis represents the time and the vertical axis represents the reflectivity.

In the voltage graph, the horizontal axis represents the time and the vertical axis represents the voltage.

In the example of FIG. 7, as the time on the horizontal axis, times t11 to t15 are shown. In the example of FIG. 8, as the time on the horizontal axis, times t21 to t25 are shown.

Here, for the vertical axis of the reflectivity graph (Rb1, Rb2, and Rw) and the vertical axis of the voltage graph (Vb, V0, and Vw), the same applies as in FIG. 6. In addition, in FIG. 7 and FIG. 8, the driving waveform is simplified in the same manner as FIG. 6.

In the example of FIG. 7, in the period of time t11 to time t15, the white display and the black display are alternately switched. Then, at time t15, in a state of carrying out the black display, the voltage is held by switching the voltage to V0 (for example, the voltage is turned off). By doing so, as the time from time t15 elapses, the white particles 162 and the black particles 163 are mixed together and the display becomes the gray display. Here, in the example of FIG. 7, an example of a gray region 311 relating to the reflectivity is shown.

In the example of FIG. 8, in the period of time t21 to time t25, the black display and the white display are alternately switched. Then, at time t25, in a state where the white display is carried out, the voltage is held by switching the voltage to V0 (for example, the voltage is turned off). By doing so, as the time from time t25 elapses, the white particles 162 and the black particles 163 are mixed together and the display becomes the gray display. Here, in the example of FIG. 8, an example of a gray region 321 relating to reflectivity is shown.

Here, in a case where the driving voltage is switched to V0 (for example, the voltage is turned off), there is a possibility of generating a residual image. That is, in such a case, in the non-holding-type device, a change from black to gray is generated as in the example in FIG. 7 and a change from white to gray is generated as in the example in FIG. 8. In addition, it is considered that the quality of the display is deteriorated in a case where the time (re-dispersion time) needed in the re-dispersion of the electrophoretic particles when changing from black to gray and the time (re-dispersion time) needed in the re-dispersion of the electrophoretic particles when changing from white to gray are different. As a specific example, the display contrast is gradually reduced in the non-holding-type device when the driving voltage is switched to V0 (for example, the voltage is turned off); however, it is considered that the display quality is further deteriorated when the time for moving from the white display to the gray display and the time for moving from the black display to the gray display are different.

Then, in the electrophoretic display device 1 according to the present embodiment, the re-dispersion time from black to gray and the re-dispersion time from white to gray are set to be the same (or may be substantially the same). Specifically, the time until a predetermined gray is reached after the voltage is switched to V0 in a black state and the time until a predetermined gray is reached after the voltage is switched to VO in a white state are set to be the same (or may be substantially the same).

In the present embodiment, for example, the diffusion speed of the white particles 162 and the black particles 163 is set to be the same (or may be substantially the same) by adjusting one or more of the parameters among the concentration of the white particles 162, the concentration of the black particles 163, the ratio of the mixture of the white particles 162 and black particles 163, the ratio of the charges of the white particles 162 and the black particles 163, or the like. Due to this, it is possible to set the re-dispersion time from black to gray and the re-dispersion time from white to gray to be the same (or substantially the same) and to prevent the deterioration of the display quality. As an example, a configuration may be used in which the reflectivity of the electrophoretic particles (in the present embodiment, the white particles 162 and the black particles 163) is within a predetermined range after a predetermined period after switching the applied voltage from Vb or Vw to V0.

### Example of Adjustment of Particle Brush Amount

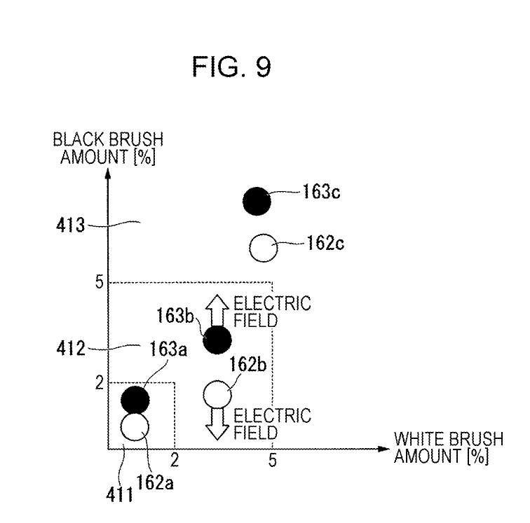

FIG. 9 is a diagram for illustrating adjustment of the particle brush amount according to one embodiment of the invention.

In the graph shown in FIG. 9, the horizontal axis represents the particle brush amount of the white particles 162 (referred to below as the “white brush amount”) [%] and the vertical axis represents the particle brush amount of the black particles 163 (referred to below as the “black brush amount”) [%].

The example of FIG. 9 shows a first region 411, a second region 412, and a third region 413. The first region 411 is a region where the white brush amount and the black brush amount are less than 2%. The second region 412 is a region where the white brush amount and the black brush amount are 2% or more to less than 5%. The third region 413 is a region where the white brush amount and the black brush amount are 5% or more.

In the first region 411, the electrophoretic particles (in the example of FIG. 9, white particles 162a and black particles 163a) are strongly coupled. In the first region 411, the electrophoretic particles are not easily separated even when a predetermined electric field (for example, a 15V electric field) is applied between the pixel electrodes 131 (the same also applies to the other pixel electrodes 132 and 133) and the counter electrode 141.

In the second region 412, the electrophoretic particles (in the example of FIG. 9, the white particles 162b and the black particles 163b) are weakly coupled. In the second region 412, the electrophoretic particles are separated by applying an electric field which is a predetermined electric field (for example, a 15V electric field) or less between the pixel electrodes 131 (the same also applies to the other pixel electrodes 132 and 133) and the counter electrode 141.

In the third region 413, the electrophoretic particles (in the example of FIG. 9, the white particles 162c and the black particles 163c) are non-coupled (that is, not coupled). In the third region 413, even when the electric field is not applied between the pixel electrodes 131 (the same also applies to the pixel electrodes 132 and 133) and the counter electrode 141, the electrophoretic particles are separated by Brownian motion or the like.

In the present embodiment, in order to make the non-holding-type device, as the particle brush amount which is able to suppress the coupling of the electrophoretic particles, the particle brush amount of the third region 413 is used. That is, a particle brush amount where the white brush amount and the black brush amount are 5% or more is used. Due to this, the electrophoretic particles are dispersed and mixed naturally.

In addition, in the present embodiment, the reflectivity is aligned by setting the re-dispersion time from black to gray and the re-dispersion time from white to gray to be the same (or substantially the same). The adjustment which aligns the reflectivity after turning off the application of the driving voltage in this manner may, for example, be performed based on experiment or the like or may be performed based on theory.

### Example of Interaction Between Electrophoretic Particles and Electrodes

An example will be given of interaction between the electrophoretic particles and the electrodes. Below, description will be given of a case of using fluorine and a case of adjusting the brush amount.

In the present embodiment, in a state where a voltage applied between the pixel electrodes 131 (the same also applies to the other pixel electrodes 132 and 133) and the counter electrode 141 is V0 (in the present embodiment, V0=0), for one or both of the pixel electrodes 131 and the counter electrode 141, the resultant force acting between the electrophoretic particles and the electrode when the electrophoretic particles approach the electrodes is set to be a repulsive force. As an example, the resultant force when the distance between the electrophoretic particles and the electrodes is between a first value up to a second value (the second value is a value greater than the first value) may be a repulsive force.

### Case of Using Fluorine

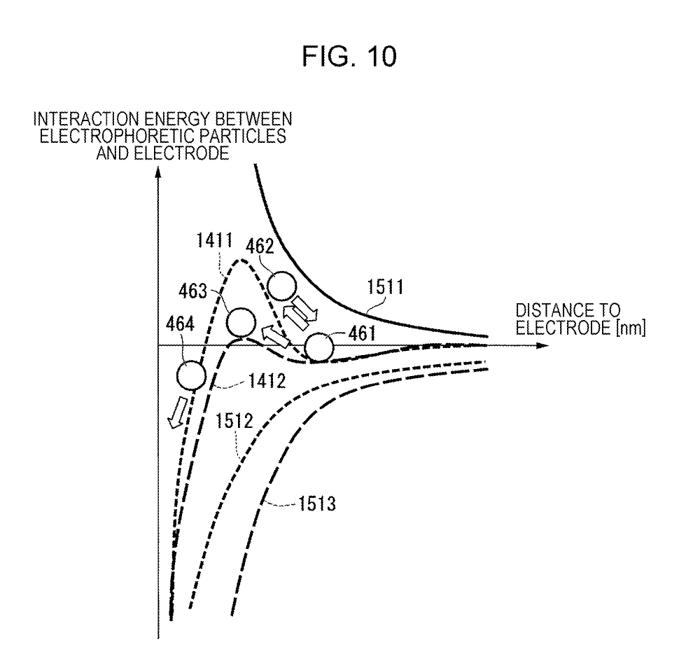

FIG. 10 is a diagram which shows an example of interaction between electrophoretic particles and electrode in a case of using fluorine.

In the graph shown in FIG. 10, the horizontal axis represents the distance [nm] between the electrophoretic particles (in the present embodiment, the white particles 162 or the black particles 163) and the electrodes and the vertical axis represents the interaction energy between the electrophoretic particles and the electrodes.

Here, in the present embodiment, the electrode is the counter electrode 141 provided on the counter substrate 102. In addition, in the present embodiment, the distance between the electrophoretic particles and the electrode is the distance between the electrophoretic particles and the surface (in the present embodiment, the surface of the second bonding layer 122) on the side of the counter electrode 141 provided on counter substrate 102.

The example of FIG. 10 shows a characteristic 1411 of the resultant force in a case where the non-holding-type device using fluorine according to the present embodiment and a characteristic 1412 of the resultant force in a case of the holding-type device according to the comparative example.

In addition, the example of FIG. 10 shows a characteristic 1511 of the repulsive force, a characteristic 1512 of attraction in the case of a non-holding-type device using fluorine according to the present embodiment, and a characteristic 1513 of attraction in the case of a holding-type device according to the comparative example.

Here, in the present embodiment, a fluorine layer is provided on the surface (in the present embodiment, the surface of the second bonding layer 122) of the side of the counter electrode 141 provided on the counter substrate 102. This layer may, for example, be an affixed fluorine film layer or may be a coated fluorine resin layer. The counter electrode 141 is, for example, formed using ITO.

In addition, in the comparative example, fluorine is not used in this manner. In addition, the counter electrode is, for example, formed using ITO.

The repulsive force characteristic 1511 is common to a case of a non-holding-type device according to the present embodiment and a case of a holding-type device according to the comparative example. The repulsive force characteristic 1511 is caused by the repulsive force due to the forming of an electric double layer of the electrophoretic particles and the surface of the electrode and the depletion effect of the brush part of the electrophoretic particles.

The characteristic 1512 of the attraction in the case of the non-holding-type device according to the present embodiment is due to intermolecular force.

The characteristic 1513 of the attraction in the case of a holding-type device according to the comparative example is due to the intermolecular force and the imaging force.

The characteristic 1411 of the resultant force in the case of a non-holding-type device according to the present embodiment is a characteristic of the resultant force of the repulsive force characteristic 1511 and the attraction force characteristic 1512. In the characteristic 1411 of the resultant force, the energy barrier is high and, for this reason, the electrophoretic particles are dispersed in the dispersion medium 161 without approaching the surface of the electrode.

Specifically, fluorine has a low surface polarity since the C═F bond is stable and, even when the electrophoretic particles are close to the electrode, the energy barrier according to the repulsive force is high and the electrophoretic particles are no longer able to approach the electrode beyond a predetermined distance. As a result, the electrophoretic particles are dispersed in the dispersion liquid 151 without being fixed on the surface of the electrode (without being held). In this manner, the electrophoretic particles are repelled from the electrode.

The example of FIG. 10 shows a case where, as a non-holding-type image, the electrophoretic particles move forward and backward between a position 461 and a position 462; however, the particles do not approach the surface of the electrode beyond this point.

The characteristic 1412 of the resultant force in the case of a holding-type device according to the comparative example is a characteristic of the resultant force of the repulsive force characteristic 1511 and the attraction force characteristic 1513. In the characteristic 1412 of the resultant force, the energy barrier is low and the electrophoretic particles approach the surface of the electrode and are fixed to the surface of the electrode.

Specifically, when the electrophoretic particles approach the electrode, since the intermolecular force and imaging force are large, the energy barrier is low and the electrophoretic particles approach and are fixed to the surface of the electrode due to the attraction force.

The example of FIG. 10 shows a case where, as a holding-type image, the electrophoretic particles move from the position 461 to a position 463 and then move to a position 464.

### Case of Adjusting Brush Amount

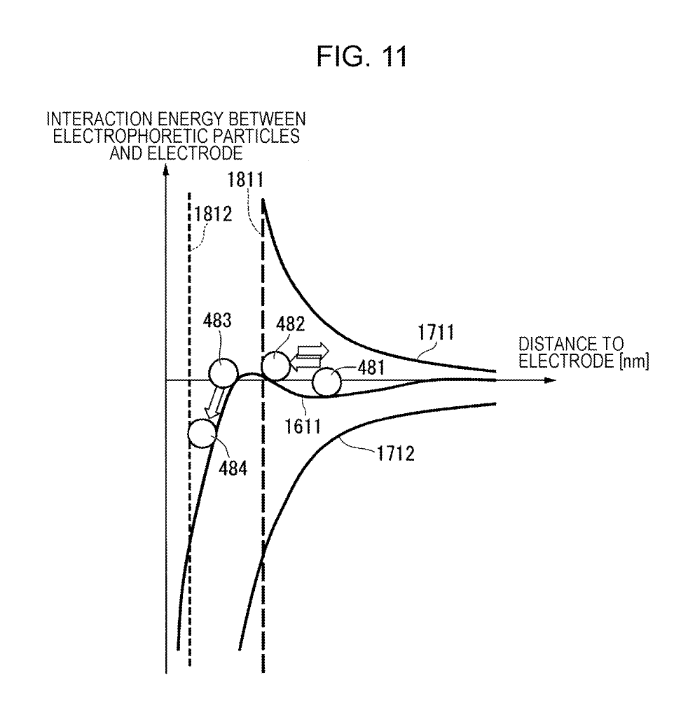

FIG. 11 is a diagram which shows an example of interaction between electrophoretic particles and electrode in a case of using the adjustment of the brush amount.

In the graph shown in FIG. 11, the horizontal axis represents the distance [nm] between the electrophoretic particles (in the present embodiment, the white particles 162 or the black particles 163) and the electrodes and the vertical axis represents the interaction energy between the electrophoretic particles and the electrodes.

Here, in the present embodiment, this electrode is the counter electrode 141 provided on the counter substrate 102. In addition, in the present embodiment, the distance between the electrophoretic particles and the electrode is the distance between the electrophoretic particles and the surface (in the present embodiment, the surface of the second bonding layer 122) on the side of the counter electrode 141 provided on the counter substrate 102.

The example of FIG. 11 shows a resultant force characteristic 1611, a repulsive force characteristic 1711, and an attraction force characteristic 1712. These are in common to the case of the non-holding-type device according to the present embodiment and the case of the holding-type device according to the comparative example.

Here, in the present embodiment, the brush amount of the electrophoretic particles (here, the white particles 162 and the black particles 163) is increased (compared to the comparative example). The counter electrode 141 is, for example, formed using ITO.

In addition, in the comparative example, the brush amount of the electrophoretic particles is small (compared to the present embodiment). In addition, the counter electrode is, for example, formed using ITO.

The repulsive force characteristic 1711 is caused by the repulsive force due to the forming of an electric double layer of the electrophoretic particles and the surface of the electrode, the steric repulsion of the brush part of the electrophoretic particles, and the depletion effect of the brush part of the electrophoretic particles. Here, for the case of the non-holding-type device according to the present embodiment, the influence of the steric repulsion of the brush part of the electrophoretic particles is greater in comparison with a case of a holding-type device according to the comparative example.

The attraction force characteristic 1712 is due to the intermolecular force and the image force.

The resultant force characteristic 1611 is the characteristic of the resultant force of the repulsive force characteristic 1711 and the attraction force characteristic 1712.

In a case of the non-holding-type device according to the present embodiment, the brush amount of the electrophoretic particles is increased. Specifically, when the electrophoretic particles approach the electrode, since the steric repulsion force is large, the electrophoretic particles are adjusted so as to be dispersed without approaching the electrode.

The example of FIG. 11 shows a boundary line 1811 in a case where the brush amount of the electrophoretic particles is 12%. In such a case, since the steric repulsion distance between the electrophoretic particles and the surface of the electrodes (the distance of the boundary line 1811) is long, the electrophoretic particles are dispersed in the dispersion liquid 151 without being fixed to the surface of the electrode even when approaching the surface of the electrode. In this manner, the electrophoretic particles are repelled from the electrode.

The example of FIG. 11 shows a case where, as the non-holding-type image, the electrophoretic particles moves forward and backward between a position 481 and a position 482; however, the particles do not approach the surface of the electrode beyond this point.

In the case of the holding-type device according to the comparative example, the amount of the brush part of the electrophoretic particles is small (compared to the present embodiment). Specifically, when the electrophoretic particles approach the electrode, since the steric repulsion force is small, the electrophoretic particles approach and are fixed to the electrode.

The example of FIG. 11 shows a boundary line 1812 in a case where the amount of the brush part of the electrophoretic particles is 3%. In such a case, since the steric repulsion distance (distance of the boundary line 1812) between the electrophoretic particles and the surface of the electrode is short, the electrophoretic particles approach and are fixed to the surface of the electrode.

The example of FIG. 11 shows a case where, as the holding-type image, the electrophoretic particles move from the position 481 to a position 483 and then to a position 484.

Here, the example of FIG. 11 shows a configuration in which the brush amount of the electrophoretic particles is increased; however, as another configuration example, a configuration may be used in which the length of the brush part of the electrophoretic particles is increased.

### Method of Manufacturing Display Portion of Non-Holding-type Electrophoretic Display Device

Description will be given of a method of manufacturing the non-holding-type electrophoretic display device 1 (in particular, the display portion 11 of the electrophoretic display device 1) according to the present embodiment.

### Example of Method of Manufacturing Non-Holding-Type Device Using Fluorine

In the present example, the display portion 11 of the non-holding-type electrophoretic display device 1 is manufactured by performing a step of providing fluorine (for example, a step of forming a fluorine layer) on the surface (in the present embodiment, the surface of the second bonding layer 122) in contact with the electrophoretic particles (in the present embodiment, the white particles 162 and the black particles 163) on the side of the counter electrode 141 provided on the counter substrate 102.

As a method of providing fluorine, for example, a method of performing coating or a method of affixing a film may be used.

### Example of Method of Manufacturing Non-Holding-type Adjusting Particle Brush

In the present example, the display portion 11 of the non-holding-type electrophoretic display device 1 is manufactured by performing a step of providing the dispersion liquid 151 in which the brush part of the electrophoretic particles (in the present embodiment, the white particles 162 and the black particles 163) is adjusted.

As a method of adjusting the brush part of electrophoretic particles, for example, a method of increasing the brush amount added to the electrophoretic particles or a method of lengthening the brush part added to the electrophoretic particles may be used.

### Summary of First Embodiment

As described above, the electrophoretic display device 1 according to the present embodiment is provided with the non-holding-type display portion 11 which does not hold the display contents when the driving voltage is stopped.

Accordingly, in the electrophoretic display device 1 according to the present embodiment, it is possible to increase the response speed of the particles (electrophoretic particles). Due to this, in the electrophoretic display device 1 according to the present embodiment, it is possible to increase the switching speed of the display contents.

In addition, in the electrophoretic display device 1 according to the present embodiment, it is possible to prevent the electrophoretic particles being fixed to the surface (in the present embodiment, the surface of the second bonding layer 122) of the electrode (in the present embodiment, the counter electrode 141). Due to this, in the electrophoretic display device 1 according to the present embodiment, it is possible to prevent burn in over time or residual images.

In addition, in the electrophoretic display device 1 according to the present embodiment, it is possible to achieve an improvement in the display quality (compared to a case of not using such a configuration) by setting the re-dispersion time from black to gray (or white) when the driving voltage is stopped and the re-dispersion time from white to gray (or black) to be the same (or substantially the same).

In addition, in the electrophoretic display device 1 according to the present embodiment, when the display contents are held, it is possible to lower the power consumption by shortening the pulse width of the driving voltage (in the present embodiment, the pulse time width) or shortening the duty of the driving voltage.

In addition, in the present embodiment, it is possible to provide a method of manufacturing the electrophoretic display device 1 described above.

Here, the present embodiment illustrated a configuration example provided with a fluorine layer on a surface on the side of the counter electrode 141 provided on the counter substrate 102 (in the present embodiment, the surface in contact with the dispersion liquid 151) or a surface on the side of the pixel electrodes 131 to 133 provided on the pixel substrate 101 (in the present embodiment, the surface in contact with the dispersion liquid 151). In this regard, as another configuration example, a configuration may be used in which, instead of a fluorine layer, a layer of a material other than fluorine is provided. As the layer of a material other than fluorine, for example, a layer having water repellency, or a layer having oil repellency may be used.

### Second Embodiment

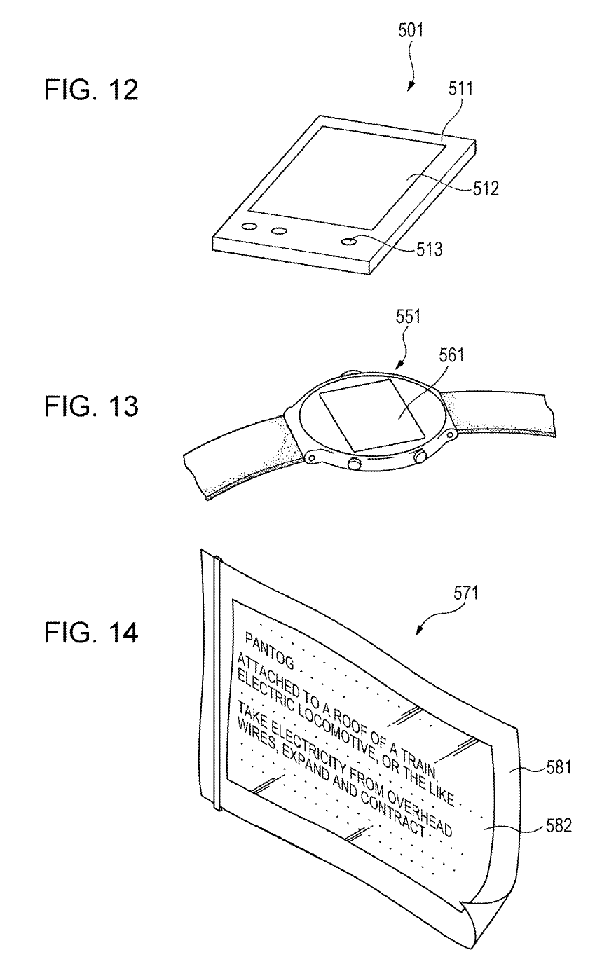

With reference to FIG. 12 to FIG. 14, a schematic configuration example of an electronic apparatus according to an embodiment of the invention will be illustrated. In the present embodiment, specific examples of electronic apparatuses in which the electrophoretic display device (the electrophoretic display device 1 according to the first embodiment) according to the above embodiment is applied.

FIG. 12 is a diagram which shows a schematic configuration example of an electronic apparatus according to an embodiment (first example of second embodiment) of the invention.

Specifically, FIG. 12 is a perspective diagram which shows an electronic book 501 which is an example of an electronic apparatus.

The electronic book 501 is provided with a book-shaped frame 511, a display portion 512 to which the electrophoretic display device 1 according to the above embodiment is applied, and an operation portion 513.

FIG. 13 is a diagram which shows a schematic configuration example of electronic apparatus according to an embodiment (second example of the second embodiment) of the invention.

Specifically, FIG. 13 is a perspective diagram which shows a wrist watch 551 which is an example of an electronic apparatus.

The wrist watch 551 is provided with a display portion 561 to which the electrophoretic display device 1 according to the above embodiment is applied.

FIG. 14 is a diagram which shows a schematic configuration example of electronic apparatus according to an embodiment (third example of the second embodiment) of the invention.

Specifically, FIG. 14 is a perspective diagram which shows an electronic paper 571 which is an example of an electronic apparatus.

The electronic paper 571 is provided with a main body 581 which is formed of a rewritable sheet which has the same texture and flexibility as paper, and a display portion 582 to which the electrophoretic display device 1 according to the above embodiment is applied.

Here, the electrophoretic display device 1 according to the above embodiment may be applied to various other electronic apparatuses, for example, the display portions of electronic apparatuses such as mobile phones and portable audio devices, and may be applied to industrial uses such as manuals, textbooks, exercise books, information sheets, and the like.

As described above, in the electronic apparatus according to the present embodiment, it is possible to obtain the same effect as the electrophoretic display device 1 according to the above embodiment.

### Summary of Above Embodiments

According to one configuration example, there is an electrophoretic display device (in the embodiment, the electrophoretic display device 1) provided with a first substrate (in the embodiment, the pixel substrate 101) and a second substrate (in the embodiment, the counter substrate 102) which are made to oppose each other, a first electrode (in the embodiment, the pixel electrodes 131 to 133) provided on the first substrate, a second electrode (in the embodiment, the counter electrode 141) provided on the second substrate, and a dispersion liquid (in the embodiment, the dispersion liquid 151) which includes particles provided between the first electrode and the second electrode (in the embodiment, the white particles 162 and the black particles 163) and a dispersion medium (in the embodiment, the dispersion medium 161), in which, from a state where colors are displayed on the side of the second substrate (in the embodiment, the display surface) by applying a voltage (in the embodiment, the voltage Vw and the voltage Vb) for displaying colors (in the embodiment, white corresponding to the white particles 162 and black corresponding to the black particles 163) corresponding to particles between the first electrode and the second electrode, in a case where the voltage is cancelled (in the embodiment, set to a voltage V0 (=0)), a color (in the embodiment, for example, gray) other than the color corresponding to the particles is displayed. In this manner, in the non-holding-type electrophoretic display device, when the driving voltage for displaying the color (in the embodiment, white and black) corresponding to the particles is cancelled, the color of the display changes to a neutral color (in the embodiment, gray) between the colors corresponding to the particles.

As a configuration example, in the electrophoretic display device, in a state where a voltage is not applied between the first electrode and the second electrode, for one or both of the first electrode and the second electrode, the resultant force acting between the electrode and the particles when the electrode and the particles are close is a repulsive force (for example, the example of FIG. 10 and the example of FIG. 11).

As a configuration example, in the electrophoretic display device, for one or both of the first electrode and the second electrode, a water-repellent or oil-repellent layer is provided on the surface where the dispersion liquid is in contact with the side of the electrode (for example, the examples in FIG. 2 to FIG. 5, and the example in FIG. 10).

As a configuration example, in the electrophoretic display device, the above layer is a fluorine layer (for example, the examples in FIG. 2 to FIG. 5, and the example in FIG. 10).

As a configuration example, in the electrophoretic display device, the amount or length of the brush part of the particles is set to a value where the resultant force acting between the electrode and the particles is a repulsive force when the electrode and the particles are close for one or both of the first electrode and the second electrode (for example, the example in FIG. 11).

As a configuration example, there is an electronic apparatus provided with the above electrophoretic display device (for example, the examples in FIG. 12 to FIG. 14).

As a configuration example, there is a manufacturing method for manufacturing the above electrophoretic display device.

As an example, there is a manufacturing method for manufacturing an electrophoretic display device provided with a first substrate and a second substrate which are made to oppose each other, a first electrode provided on the first substrate, a second electrode provided on the second substrate, and a dispersion liquid including particles and a dispersion medium provided between the first electrode and the second electrode, in which the following steps are performed. That is, in the method of manufacturing the electrophoretic display device, one or both steps of forming a water repellent or an oil repellent layer on a surface where the dispersion liquid is in contact with the side of the electrode for one or both of the first electrode and the second electrode, or providing a dispersion liquid where the amount or length of the brush part of the particles is set to a value where the resultant force acting between the electrode and the particles is a repulsive force when the electrode and the particles are close for one or both of the first electrode and the second electrode are performed.

A description was given above of an embodiment of the invention with reference to the drawings; however, the specific configuration is not limited to the embodiment and also includes designs or the like in a range which does not depart from the gist of the invention.

Here, a program for implementing the functions of arbitrary constituent portions (for example, the control portion, and the like) in the device (for example, the electrophoretic display device 1 or the electronic apparatus) described above may be executed by being recorded (stored) onto a computer-readable recording medium (storage medium) and loaded into a computer system. Here, the term “computer system” includes an operating system (OS) or hardware such as peripheral devices. In addition, the term “computer-readable recording medium” refers to a portable medium such as a flexible disk, a magneto-optical disc, a Read Only Memory (ROM), a Compact Disk (CD)-ROM, or the like, or a storage device such as a hard disk built in a computer system. Furthermore, the “computer-readable recording medium” also includes a medium holding a program for a set time such as a volatile memory (Random Access Memory: RAM) in the computer system serving as a server or client in a case where a program is transmitted via a network such as the internet or a communication line such as a telephone line.

In addition, the program described above may be transferred from a computer system storing the program in a storage device or the like to another computer system via a transmission medium or by transmission waves in the transmission medium. Here, the “transfer medium” which transfers the program refers to a medium which has a function of transferring information such as a network (a communication network) such as the internet or a communication line such as a telephone line.

In addition, the program described above may be a program for realizing some of the functions described above. Furthermore, the program described above may be a program which is able to realize the functions described above by a combination of programs pre-recorded in a computer system, so-called differential file (differential program).

The entire disclosure of Japanese Patent Application No. 2016-010751, filed Jan. 22, 2016 is expressly incorporated by reference herein.

What is claimed is:

1. An electrophoretic display device comprising:
a first substrate and a second substrate opposed each other;
a first electrode provided on the first substrate;
a second electrode provided on the second substrate; and
a dispersion liquid which includes particles and a dispersion medium, provided between the first electrode and the second electrode,
wherein, in a state where a voltage for displaying colors corresponding to the particles is applied between the first electrode and the second electrode and the colors are displayed on a side of the second substrate, in a case where the voltage is cancelled, a color other than the color corresponding to the particles is displayed.

2. The electrophoretic display device according to claim 1,
wherein, in a state where a voltage is not applied between the first electrode and the second electrode, for one or both of the first electrode and the second electrode, a resultant force acting between the electrodes and the particles when the electrodes and the particles are close is a repulsive force.

3. The electrophoretic display device according to claim 1,
wherein, for one or both of the first electrode and the second electrode, a water-repellent or oil-repellent layer is provided on a surface where the dispersion liquid contacts a side of the electrode.

4. The electrophoretic display device according to claim 3,
wherein the layer is a fluorine layer.

5. The electrophoretic display device according to claim 1,
wherein, for one or both of the first electrode and the second electrode, an amount or length of a brush part of the particles is set to a value where the resultant force acting between the electrode and the particles is a repulsive force when the electrode and the particles are close.

6. An electronic apparatus comprising:
the electrophoretic display device according to claim 1.

7. An electronic apparatus comprising:
the electrophoretic display device according to claim 2.

8. An electronic apparatus comprising:
the electrophoretic display device according to claim 3.

9. An electronic apparatus comprising:
the electrophoretic display device according to claim 4.

10. An electronic apparatus comprising:
the electrophoretic display device according to claim 5.

11. A method of manufacturing an electrophoretic display device provided with a first substrate and a second substrate opposed each other, a first electrode provided on the first substrate, a second electrode provided on the second substrate, and a dispersion liquid which includes particles and a dispersion medium, provided between the first electrode and the second electrode, the method comprising:
performing one or both of
forming a water-repellent or oil-repellent layer on a surface where the dispersion liquid contacts a side of the electrode for one or both of the first electrode and the second electrode, or
providing the dispersion liquid where, for one or both of the first electrode and the second electrode, an amount or length of a brush part of the particles is set to a value where a resultant force acting between the electrode and the particles is a repulsive force when the electrode and the particles are close.
